(19) United States
(12) Patent Application Publication
(10) Pub. No.: US 2007/0049378 A1
(43) Pub. Date: Mar. 1, 2007

(54) Shock absorbing hub

(76) Inventors: Kria Henderson, Lafayette, LA (US); Jeremy Louviere, Lafayette, LA (US)

Correspondence Address: Ted M. Anthony, Suite 1200, 600 Jefferson Street, Lafayette, LA, 70501, US

(21) Appl. No.: 11/217,140

(22) Filed: Aug. 31, 2005

(51) Int. Cl. F16D 3/52

(52) U.S. Cl. 464/76

(57) ABSTRACT

A shock absorbing hub comprises an outer substantially circular plate member having an outer peripheral shoulder, a central bore defining an inner shoulder and a plurality of teeth fingers extending from the inner edge. An inner substantially circular plate member, having an outer peripheral shoulder and a plurality of rigid teeth forming fingers extending from the outer peripheral edge, is disposed within the central bore of the outer plate member. The rigid fingers of the inner plate are received between the fingers of the outer plate. Compression elements are spaced between the fingers of the outer plate and the fingers of the inner plate.

### CROSS REFERENCES TO RELATED APPLICATIONS

NONE

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention relates to a shock absorbing hub. More particularly, the present invention relates to a shock absorbing hub that can be incorporated in a rotating element used to transmit or transfer torque. More particularly still, the present invention relates to a hub incorporated in a rotating element used to transmit or transfer torque that can absorb shock impulses resulting from shock event conditions.

2. Description of the Prior Art

The use of rotating elements to transfer torque is well known in the art. For example, gear trains comprising a plurality of intermeshing gears are commonly used to transfer torque in a wide variety of applications. Similarly, chain drive mechanisms routinely incorporate sprockets for the transfer of torque, while belt drive mechanisms frequently utilize sheaves for this purpose. Many other drive mechanisms also employ rotating elements in order to impart or transfer torque.

Generally, such mechanisms perform at their best when rotating elements and related components are exposed to substantially even loading conditions. However, when such loading conditions are uneven or sporadic, a shock impulse can be created that can transfer or resonate throughout an entire mechanism and its individual components. Such shock impulses can dramatically reduce the performance of such systems. Under extreme circumstances, these shock impulses can cause such mechanisms and/or their individual components to be damaged or even fail.

By way of illustration, but not limitation, it is to be observed that gear trains can often encounter torque overload conditions. When such overloading occurs, the teeth of certain gears can, at least for a short period of time, bear a disproportionately greater share of the load than the teeth of the other gear(s) in the gear train. Any such overload situation, even if it is momentary, can generate damaging stresses that can resonate throughout a gear train. These stresses can negatively impact the gear train, in general, and the teeth, shafts and/or bearings of individual gears in such gear train, in particular. This phenomenon, which is not limited to gear trains, can also be encountered by other torque transmission mechanisms, such as chain drive and/or belt drive mechanisms.

Load equalizing gears of various sorts have been disclosed in the prior art. However, these load equalizing gears involve relatively complicated structures having a number of interconnected parts. Due to the complexity of the structures, such gears can be difficult to remove from the mechanisms in which they are installed. Moreover, such gears can be difficult to repair or redress, and to re-install within such mechanisms.

For example, one prior art load equalizing gear has been disclosed in connection with a drive train for power tongs typically used in the oil and gas industry to make up and break apart threaded tubular goods. However, said prior art load equalizing gear is custom tailored to the complex multiple gear trains of the specific device at issue. Said prior art load equalizing gear is comprised of a number of interconnected but separate pieces, and functions primarily to align individual components of a complex system involving multiple gear trains. As such, the prior art device is not as versatile as the present invention, and does not provide protection to multiple components of a drive train like the shock absorbing hub of the present invention. Moreover, as set forth above, the shock absorbing hub of the present invention is much more versatile than the load equalizing gear of the prior art. As such, the present invention can be used in many different devices and/or applications than simply power tongs.

Thus, there is a need for a simple, light-weight shock absorbing hub that can be employed as a rotating element in connection with drive mechanisms and/or other devices used for the transmission and/or transfer of torque. Such rotating elements can include, but are not necessarily limited to, gears, sprockets, sheaves and the like. Moreover, there is a need for a shock absorbing hub that is easy to install within, and remove from, drive trains used for the transfer of torque and/or devices incorporating such drive trains. Further, the shock absorbing hub should be easy to repair, and permit the amount of radial resistance offered by such hub (that is, the amount of shock that can be absorbed) to be easily adjusted.

Although the shock absorbing hub can take any number of different shapes or configurations, it should ideally allow for the same basic shape or configuration as other standard rotating elements, such as for example gears, sprockets, sheaves and the like. Thus, the shock absorbing hub should be capable of being installed or retro-fit into existing devices or inventory, thereby increasing the useful life of such inventory or devices and ultimately generating monetary savings in the process.

### SUMMARY OF THE INVENTION

The shock absorbing hub of present invention includes an outer body. In the preferred embodiment, said outer body is a plate-like member having a central bore disposed there-through. Said outer body has an outer peripheral surface, as well as an inner surface defined by said central bore. The dimensions of said outer body, as well as the configuration of the outer peripheral surface of said outer body, depend upon the particular use for which such shock absorbing hub is intended. For example, but not by way of limitation, where the shock absorbing hub of the present invention is incorporated in a gear train, the outer peripheral surface of said outer body could have a plurality of teeth that extend radially outward along such outer surface. Alternatively, where the shock absorbing hub of the present invention is used as a sheave, the outer body could have a circumferential groove around its outer peripheral edge. A plurality of rigid members extend inwardly from the inner surface of said outer body into said central bore.

A substantially circular inner member having a peripheral outer surface is concentrically received within the central bore of said outer body. Said inner member has a plurality of rigid fingers extending radially outward from said peripheral outer surface. Said rigid fingers are disposed within recesses defined along the inner surface of the central bore of said outer body. In this configuration, the outwardly extending fingers of said inner member are received, in alternating fashion, between the inwardly extending rigid members of said outer body. As such, each inwardly extending rigid member (of the outer body) and the immediately adjacent outwardly extending finger (of the inner member) combine to form a pair of opposing rigid surfaces. In the preferred embodiment, a retaining plate is affixed to one face of said outer body in order to hold said inner member, as well as certain other components, discussed below, in place.

A plurality of compressible biasing elements are disposed between the inwardly extending rigid members of said outer body and the outwardly extending fingers of said inner member. In the preferred embodiment, said compressible biasing elements may be constructed from polyurethane; however, said compressible elements are not limited to polyurethane or any other particular material, but may be constructed of any suitable resilient material. Said biasing elements can be compressed, thereby allowing mechanical energy to be absorbed before returning to a “normal compression state,” “neutral” or rest position. It will be readily apparent that said biasing inserts act to dampen or absorb the force of any relative movement between said inner member and said outer body.

In the preferred embodiment, a bore is disposed through the center of said inner member. A rigid element, such as a cylindrical drive shaft, is received within said bore. Further, in the preferred embodiment, said shaft has a splined outer surface and said central bore has a mating profile. However, it is to be observed that the rigid element is not limited to a shaft; said element can have any number of different configurations as more fully described herein.

### BRIEF DESCRIPTION OF THE DRAWINGS

FIG. 1 is an exploded perspective view of the shock absorbing hub of the present invention.

FIG. 2 is a front view of the shock absorbing hub of the present invention.

FIG. 3 is a side view of the shock absorbing hub of the present invention.

FIG. 4 is a side exploded view of the shock absorbing hub of the present invention without a drive shaft installed.

FIG. 5 depicts a side perspective view of a shock absorbing hub of the present invention in connection with a sprocket apparatus.

### DETAILED DESCRIPTION OF THE PRESENT INVENTION

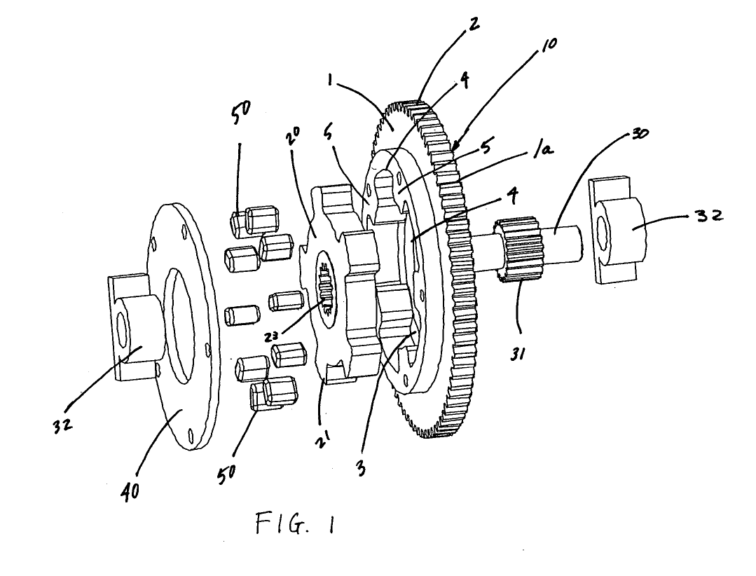

Referring to the drawings, FIG. 1 depicts an exploded perspective view of shock absorbing hub 10 of the present invention. As previously discussed, shock absorbing hub 10 of the present invention can be used in any number of different applications incorporating a rotating element for the transmission or transfer of torque. For purposes of this discussion, said shock absorbing hub 10 is described in the context of gears utilized within gear trains. However, it is to be observed that shock absorbing hub 10 of the present invention can be used in connection with any number of other applications including, but not necessarily limited to, sprockets, sheaves and the like. As such, the scope of the present invention is not limited exclusively to gears and can extend to any number of other devices or mechanisms utilizing rotating elements for the transmission or transfer of torque.

As discussed above, stress, in the form of a shock impulse wave, is often caused by a torque overload causing uneven or unbalanced loading conditions. In the case of a gear train, such stress can be introduced into a gear train when the gears of such train experience a high impact load, begin movement or abruptly stop moving. Shock absorbing hub 10 of the present invention is an apparatus that reduces the harmful effects of such undesirable stresses.

Shock absorbing hub 10 generally comprises outer body 1. In this embodiment, outer body 1 is substantially in the form of a plate having a peripheral outer edge 1a. A plurality of teeth 2 are disposed along peripheral outer edge 1a of said outer body 1. Substantially circular central opening 3 extends through outer body 1. Central opening 3 defines an inner surface in outer body 1 having a plurality of alternating recesses 4 and inwardly extending rigid members 5. Said rigid members 5 extend from the inner surface of outer body 1 into central opening 3.

Substantially circular inner member 20 having a peripheral outer edge 20a is concentrically received within central opening 3 of outer body 1. Said inner member 20 has a plurality of rigid fingers 21 extending radially outward from said peripheral outer edge 20a of inner member 20, thereby defining a plurality of sockets 22 disposed between said rigid fingers 21 along said peripheral outer edge 20a. Said rigid fingers 21 of inner member 20 are received, in alternating fashion, between rigid members 5; said rigid fingers 21 are received within recesses 4 defined by central bore 3 of outer body 1. Said inwardly extending rigid members 5 and outwardly extending rigid fingers 21 combine to form opposing surfaces.

In the preferred embodiment of the present invention, retaining plate 40 is affixed to one face of outer body 1 or inner member 20. Although retaining plate 40 can be affixed in any number of ways, in the preferred embodiment retaining plate 40 is frictionally attached to inner member 20. Alternatively, retaining plate 40 can be attached to outer body 1 or inner member 20 using mechanical fasteners.

A plurality of compressible biasing elements 50 are disposed between inwardly extending rigid members 5 of outer body 1 and adjacent outwardly extending rigid fingers 21 of inner member 20. In the preferred embodiment, compressible biasing elements 50 are constructed of polyurethane. However, said compressible biasing elements 50 are not limited to polyurethane elements, but may be constructed of any suitable resilient material(s) that allows a rigid finger 21 of inner member 20 to move toward a rigid member 5 of outer body 1 and permits mechanical energy to be absorbed before returning to a “neutral” or a rest position. It will be readily apparent that said compressible biasing elements 50 act to dampen or absorb the force of any relative movement between said inner member and said outer body 1.

In the preferred embodiment, bore 23 is disposed through said inner member 20. Shaft 30, in this embodiment a cylindrical shaft used to support shock absorbing hub 10, is received within said bore 23. Further, in the preferred embodiment, said shaft 30 has a splined outer surface area 31, while said central bore 23 of inner member 20 has a mating profile. Shaft 30 is received within central bore 23 of inner member 20. Although shock absorbing hub 10 of the present invention can be mounted in many different configurations, in this embodiment shaft 30 is anchored using mounting brackets 32. In this configuration, the shock absorbing hub of the present invention can rotate about an axis passing through shafts 30, and can be incorporated within a typical gear train.

It should be noted that the shock absorbing hub of the present invention can be mounted using means other than shaft 30 as disclosed herein. For example, said shock absorbing hub could be mounted using a drive shaft, pinion gear apparatus or shearable mounting device. In fact, shock absorbing hub 10 of the present invention can be mounted using any means that permits the transmission of torque.

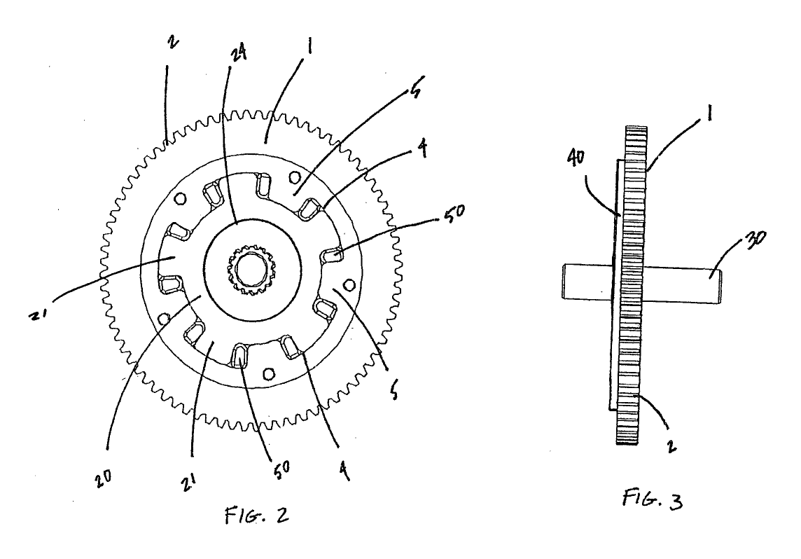

FIG. 2 depicts a front view of shock absorbing hub 10 of the present invention. Outer body 1 is substantially in the form of a plate, and includes a plurality of teeth 2 (such as, for example, standard gear teeth) along the outer peripheral edge of said outer body 1. Central opening 3 defines an inner surface in outer body 1 having a plurality of alternating recesses 4 and inwardly extending rigid members 5.

Substantially circular inner member 20 is concentrically disposed within central opening 3 of outer body 1. Said inner member 20 has a plurality of rigid fingers extending radially outward along its outer surface, thereby defining a plurality of alternating recesses 22 disposed between said rigid fingers 21.

Still referring to FIG. 2, rigid fingers 21 are disposed between inwardly extending rigid members 5 of outer body 1; specifically, said rigid fingers 21 are received within recesses 4 defined by central bore 3 of outer body 1. In this configuration, each rigid finger 21 and immediately adjacent inwardly extending rigid members 5 combine to form opposing rigid surfaces. Compressible biasing elements 50 are disposed between such opposing rigid surfaces, in gaps existing between inwardly extending rigid members 5 of outer body 1, and outwardly extending rigid fingers 21 of inner member 20. Bore 23 having a splined outer profile is disposed through the center of inner member 20, while shaft 30 having a mating external profile, is received within said bore 23. For clarity, retaining plate 40 is not depicted in FIG. 2.

FIG. 3 depicts a side view of shock absorbing hub 10 of the present invention. Outer body 1 is substantially in the form of a plate, and includes a plurality of teeth 2 along the outer peripheral edge of said outer body 1. Shaft 30 extends through shock absorbing hub 10 of the present invention. Shaft 30 has outwardly extending radial teeth on its outer surface to permit the transmission of torque. Retaining plate 40 is held in place along one face of outer body 1.

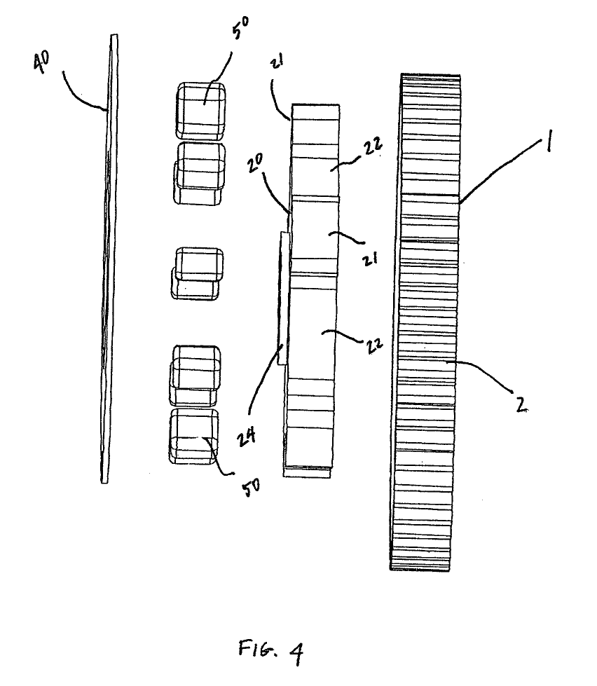

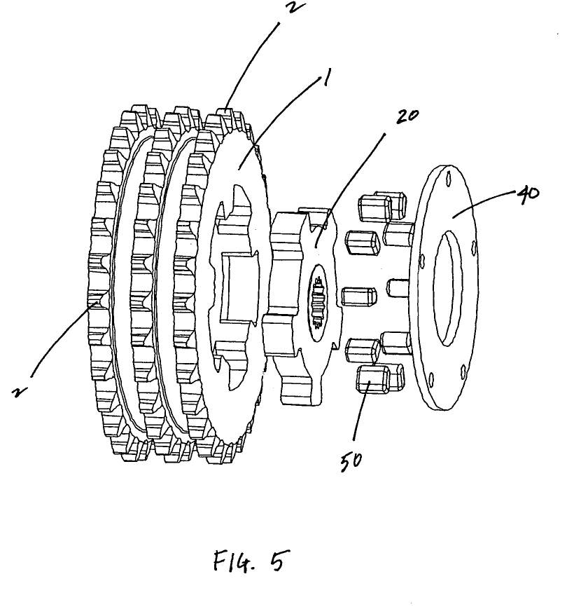

FIG. 4 depicts a side exploded view of certain elements of shock absorbing hub 10 of the present invention. Specifically, substantially circular inner member 20 is received within central opening 3 (not shown in FIG. 4) of outer body 1. A plurality of compressible biasing inserts 50 are received between said inner member 20 and outer body 1.

To illustrate the operation of shock absorbing hub 10, consider stresses created in a gear train when component gears of such train experience a shock impulse, such as when loading characteristics are disproportionately focused on individual gear(s) in a gear train. Without the inclusion of shock absorbing hub 10, a shock wave caused by such loading characteristics can be transmitted throughout the gears of the train, as well as any motor used to supply torque to such train. It will be apparent that this sequence of events places significant stresses on the teeth of such gears, and/or connected motor(s). However, if shock absorbing hub 10 is positioned within such gear train, much of this stress can be dampened or absorbed. When such gears experience a shock impulse, stresses are transferred through the gear train, and are not directly transferred to the teeth of such gears. Rather, such stresses are absorbed through compression by shock absorbing hub 10 in general, and compressible biasing elements 50, in particular.

Shock absorbing hub 10 of the present invention is a light-weight, durable and extremely versatile shock absorbing component. Although shock absorbing hub 10 is described herein with respect to a gear train, it is to be observed that said shock absorbing hub 10 can be incorporated into any number of drive trains involving the transmission and/or transfer of torque.

For example, FIG. 5 depicts the components of said shock absorbing hub incorporated within a sprocket apparatus such as may be incorporated in a typical chain-drive apparatus. As depicted in FIG. 5, shock absorbing hub comprises outer body 1 having sprocket teeth 2 and teeth 2 and central opening 3. Inner member 20 can be received within central opening 3, and compressible biasing elements 50 are disposed between said outer body 1 and inner member 20. Shock absorbing hub 10 of the present invention comprises very few component parts, and permits great flexibility in operation.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A shock absorbing hub comprising:
a. a first substantially circular plate member having an outer peripheral edge, a central bore defining an inner edge and a plurality of teeth fingers extending from said inner edge;
b. a second substantially circular plate member having an outer peripheral edge and a plurality of teeth fingers extending from said outer peripheral edge forming sockets, wherein said second plate member is received within the bore of said first plate member and said teeth fingers of said second plate are received between the fingers of said first plate;
c. a shaft fixed to said second plate member; and
d. a plurality of resilient members disposed between the teeth fingers of said first plate and the sockets fingers of said second plate.

2. The shock absorbing hub of claim 1, wherein said shaft is oriented perpendicular to said first and second plate members.

3. The shock absorbing hub of claim 1, further comprising a hole through said second plate, wherein said shaft is received within said hole.

4. The shock absorbing hub of claim 3, wherein said shaft has a splined outer surface and said hole has a mating profile.

5. The shock absorbing hub of claim 1, further comprising a plurality of teeth on the outer peripheral edge of said first plate member.

6. The shock absorbing hub of claim 1, further comprising a circumferential groove around the outer peripheral edge of said first member.

7. The shock absorbing hub of claim 1, wherein said shaft is integrally formed with said second plate member.

8. A shock absorbing hub comprising:
a. a first body member having an outer peripheral edge and a central bore defining an inner edge;
b. a plurality of extensions disposed on said inner edge of said first body;
c. a second body member having an outer edge and plurality of extensions disposed on said outer edge of said second body member, wherein said second body member is concentrically disposed within said central bore of said first body member and the extensions on said second body member are received between said extensions of said first body member;
d. a shaft fixed to said second body member; and
e. a plurality of compression elements resilient members disposed between said extensions on the inner edge of said first body and said extensions on said second body member.

9. The shock absorbing hub of claim 8, wherein said shaft is oriented perpendicular to said first and second body members.

10. The shock absorbing hub of claim 8, further comprising a hole through said second body member, wherein said shaft is received within said hole.

11. The shock absorbing hub of claim 10, wherein said shaft has a splined outer surface and said hole has a mating profile.

12. The shock absorbing hub of claim 10, further comprising a plurality of teeth on the outer peripheral edge of said first body member.

13. The shock absorbing hub of claim 10, further comprising a circumferential groove around the outer peripheral edge of said first body member.

14. The shock absorbing hub of claim 10, wherein said shaft is integrally formed with said second body member.
